(19) United States
(12) Patent Application Publication
(10) Pub. No.: US 2013/0086974 A1
(43) Pub. Date: Apr. 11, 2013

(54) PILE TESTING SYSTEM

(71) Applicant: PILE DYNAMICS, INC., Solon, OH (US)

(72) Inventor: Frank Rausche, Chagrin Falls, OH (US)

(73) Assignee: PILE DYNAMICS, INC., Solon, OH (US)

(21) Appl. No.: 13/646,261

(22) Filed: Oct. 5, 2012

Related U.S. Application Data
(60) Provisional application No. 61/543,543, filed on Oct. 5, 2011.

(51) Int. Cl. G01N 3/30

(52) U.S. Cl. 73/12.01

(57) ABSTRACT

A pile testing system for determining the load capacity of an in place pile and the system including a transducer assembly having a top extent and a bottom extent, the transducer assembly being generally fixed relative the pile top when in use and having a side wall transverse to the pile top and extending about a transducer axis, the transducer assembly further including at least one strain transducer joined to the wall of the transducer assembly, the at least one strain transducer configured to measure the applied load, the system further including at least one accelerometer fixed relative to the associated pile, the at least one accelerometer configured to calculate the movement of the associated pile when subjected to the applied load wherein the load capacity of the associated in place pile can be calculated based on the comparison between the applied load and the movement of the pile.

This application claims priority in Provisional Patent Application Ser. No. 61/543,543, which was filed on Oct. 5, 2011.

The invention of this application relates to pile testing equipment and, more particularly, to a pile testing system for determining the load capacity of an installed pile. These systems can be used in connection with a wide variety of piles including foundational piles.

### BACKGROUND OF THE INVENTION

In this respect, before a super structure is positioned on a set of installed piles, one or more of these piles are often tested to determine the load bearing capacity of the piles. Systems in the past have been used to help determine this load capacity; however, it has been found that while these systems can be effective, they are costly to operate and are difficult to transport. The invention of this application relates to a new system for testing piles to overcome and/or reduce these difficulties and costs.

Further, the data collected by the system of this application can be communicated locally or even to remote locations as desired as it is collected, at desired intervals and/or after one or more jobs are completed. Likins Jr. et al (U.S. Pat. No. 5,987,749), McVay et al (U.S. Pat. No. 6,533,502) and Piscalko (U.S. Pat. No. 6,301,551) are hereby incorporated by reference for showing data collection, data use and data communication for these kinds of systems.

Pile testing systems are known in the art. In this respect and with reference to an article titled About Dynamic Foundation Testing, obtained from applicant's website in September 2010 and which is incorporated by reference into this application and forms part of this specification, attempts to determine pile capacity using dynamic analysis date back to the 19th century. At that time, a dynamic formula that considered the energy of the pile driving hammer and the set of the pile was developed to find bearing capacity. Dynamic formulae are still used today, in spite of their inaccuracies and of the fact that they cannot predict stresses during driving.

In the 1950's, E. A. Smith of the Raymond Pile Driving Company developed a numerical analysis method to predict the capacity versus blow count relationship and investigate pile driving stresses. The model mathematically represents the hammer and all its accessories (ram, cap, cap block), as well as the pile, as a series of lumped masses and springs in a one-dimensional analysis. The soil response for each pile segment is modeled as viscoelastic-plastic.

All components of the system are thus realistically modeled. The analysis begins with the hammer ram falling and attaining an initial velocity at impact. This method is the best technique for predicting the relationship of pile capacity and blow counts (or set per blow), and the only method available to predict driving stresses. Improvements to Smith's method include work by applicant to incorporate a thermodynamic diesel hammer model and residual stresses. The applicant's Wave Equation Analysis of Piles (GRLWEAP) program is based on Smith's method.

When a hammer or drop weight strikes the top of a foundation or pile, a compressive stress wave travels down its shaft at a speed c, which is a function of the elastic modulus E and mass density. The impact induces a force F and a particle velocity v at the top of the foundation. The force is computed by multiplying the measured signals from a pair of strain transducers attached near the top of the pile by the pile area and modulus. The velocity measurement is obtained by integrating signals from a pair of accelerometers also attached near the top of the pile. Strain transducers and accelerometers are connected to a PILE DRIVING ANALYZER® (PDA) system designed by applicant, for signal processing and results.

As long as the wave travels in one direction, force and velocity are proportional:

F=Zv,
where:
   v=particle velocity
   Z=EA/c is the pile impedance
   E is the pile material modulus of elasticity
   A is the cross sectional area of the pile
   c is the material wave speed at which the wave front travels

Soil resistance forces along the shaft and at the toe cause wave reflections that travel and are felt at the top of the foundation. The times at which these reflections arrive at the pile top are related to their location along the shaft. The measured force and velocity near the pile top thus provide necessary and sufficient information to estimate soil resistance and its distribution.

Total soil resistance computed by the PDA system includes both static and viscous components. The static resistance can be obtained by subtracting the dynamic component from the total soil resistance. The dynamic component is computed as the product of the pile velocity times a soil parameter called the Damping Factor. The damping factor is an input to the PDA system and is related to soil grain size.

The energy delivered to the pile is directly computed as the work done on the pile from the integral of force times incremental displacement (∫Fdu) which is easily evaluated as force times velocity integrated over time (∫Fvdt). Maximum compression stresses at the pile top come directly from the measurements. The measurements also allow direct computation of the compression stress at the pile toe and the tension stresses along the shaft. Pile integrity can be evaluated by inspecting the measurements for early tension returns (caused by pile damage) prior to the reflection from the pile toe; lack of such reflections assures a pile with no defects.

High Strain Dynamic Testing encompasses Dynamic Pile Monitoring and Dynamic Load Testing. Both are covered by ASTM D4945. Pile Driving Monitoring consists of using a PDA system to perform real time evaluation of Case Method capacity, energy transfer, driving stresses and pile integrity for every blow. Dynamic Load Testing involves another technique that evolved from Smith's approach of modeling the wave propagation theory of pile driving, the Case Pile Wave Analysis Program (CAPWAP®). CAPWAP program combines field measurements (obtained with the PDA system) and wave-equation type analytical procedures to predict soil behavior including static-load capacity, soil resistance distribution, pile soil load transfer characteristics, soil damping and quake values, and pile load versus movement plots (e.g. a simulated static load test). CAPWAP program analysis is made on the PDA system data after the test is complete. Strain transducers and accelerometers are mounted on a pile and an impact load is applied which generates a stress wave in the pile and produces both a temporary and a permanent penetration of the pile into the ground.

Also incorporated by reference is an article titled Dynamic Load Testing obtained from applicant's website in September 2010 and which relates to dynamic load testing and devices used in connection with dynamic load testing.

Dynamic Load Testing is a fast, reliable and cost effective method of assessing foundation bearing capacity. In addition to bearing capacity, Dynamic Load Testing can give information on resistance distribution (shaft resistance and end bearing) and evaluates the shape and integrity of the foundation element.

The Dynamic Load Test involves a substantial ram mass that impacts the top of the foundation and causes it to experience a small permanent set. In order to perform the load test, an adequate hammer or drop weight is needed. Applicant offers a dynamic loading system under the brand APPLE and which is shown in FIG. 1. The current APPLE system can activate up to 4000 tons of test load, however, activating higher loads only requires greater drop weights. With reference to FIG. 1, shown are an APPLE system A that includes a support frame SF and a ram R. Ram R can be a self contained ram with an internal lifting mechanism or a ram that must be lifted by a cable C connected to a crane (not shown) which can also be used to position system A in place over a pile (also not shown). The ram produces the drop weight or testing force to the pile which is a function of its mass times it velocity as the ram impacts the pile.

Accelerometers and strain transducers are attached directly to the pile measure force and velocity as the ram hits the pile. The data can then be analyzed as desired. This data collected, can be analyzed, stored, manipulated and/or communicated in any way known in the art. This can include transmitting the data to an operating system which can be an on site system and/or an off sight system which is known in the art.

While system A has been found to be effective in the field, it requires the sensors to be positioned on the pile itself. As can be appreciated, it can be difficult and expensive to attach sensors to a pile that is substantially buried in the ground. In this situation, onsite workers must excavate around the pile to allow for the attachment of sensors to the pile. The excavated hole must be large enough and around 150 mm deep (which is an appreciable depth for the typical 1,800 mm diameter pile) to allow the sensors to be attached to the pile below the ground surface. This is made more difficult in that the hole must also be large enough to also allow tools to be used in the hole to rigidly join the sensor to the pile so that accurate measurements are obtained. Yet further, the holes drilled into the pile to mount the sensor must be drilled accurately or the sensor will not produce accurate data. As can be appreciated, this can be very difficult when drilling and attaching a sensor in a hole below ground on a pile cast against the soil which makes the surface irregular and of uncertain concrete properties (due to potential contamination of the concrete). Often this means having to grind the pile smooth and to a depth where the concrete is sound. This can be very time consuming. While this situation can be partially addressed by extending the pile above the ground surface a sufficient amount for the sensors, this extension is not always an option and can increase costs and time delays while not guaranteeing that the concrete quality is uniform and well known.

### SUMMARY OF THE INVENTION

According to the invention of this application, provided is a pile testing system and, more particularly, a pile testing system used to determine the load capacity of an installed pile.

More particularly, the system according to the invention of this application reduces testing cost and improves the testing of piles.

In this respect, provided is a pile testing system for determining the load capacity of an in place pile and the system including a transducer assembly having a top extent and a oppositely facing bottom extent, the transducer assembly being generally fixed relative the pile top when in use and having a side wall transverse to the pile top and extending about a transducer axis, the transducer assembly further including at least one strain transducer joined to the wall of the transducer assembly, the at least one strain transducer configured to measure the applied load, the system further including at least one accelerometer fixed relative to the associated pile, the at least one accelerometer configured to calculate the movement of the associated pile when subjected to the applied load wherein the load capacity of the associated in place pile can be calculated based on the comparison between the applied load and the movement of the pile.

According to other aspects of the invention, provided is a pile testing system wherein the at least one strain transducer is operably joined to the at least one side wall includes a transducer operably joined to an inner surface of the at least one side wall of the transducer assembly.

According to yet other aspects of the invention, provided is a pile testing system wherein the transducer assembly further includes a top plate and a bottom plate, at least one of the top and bottom plates being selectively removable to access the at least one strain transducer operably joined to the inner surface.

According to a further aspect of the invention, provided is a pile testing system wherein the at least one strain transducer is at least one inner strain transducer operably joined to the inside surface and the system further includes at least one outer strain transducer operably joined to an outer surface of the at least one side wall of the transducer assembly.

According to yet a further aspect of the invention, provided is a pile testing system wherein the at least one side wall is a cylindrical side wall.

According to other aspects of the invention, provided is a pile testing system wherein the at least one inner strain transducer is a plurality of inner strain transducers circumferentially spaced about cylindrical side wall and the at least one outer strain transducer is a plurality of outer strain transducers circumferentially spaced about cylindrical side wall.

According to yet other aspects of the invention, provided is a pile testing system wherein the plurality of inner strain transducers being equidistant to the transducer assembly axis and plurality of outer strain transducers being equidistant to the transducer assembly axis, the plurality of inner and outer strain transducers together measuring the applied load to both improve accuracy and detect misdirected load application.

According to even yet other aspects of the invention, provided is a pile testing system wherein the system further includes a helmet structure separating the transducer assembly from the associated pile, the helmet structure bearing against the associated top of the pile and the transducer assembly bearing against the helmet structure when the application force against the system is applied, the at least one accelerometer including a first accelerometer being operably secured to at least one of the helmet structure and an associated side surface of the associated pile.

According to further aspects of the invention, provided is a pile testing system wherein the at least one accelerometer further includes a second accelerometer, the second accelerometer being operably joined to the other of the at least one of the helmet structure and the associated side surface.

According to even yet further aspects of the invention, provided is a pile testing system wherein the helmet structure includes a horizontal plate having a top surface facing the transducer assembly and a bottom surface facing the associated pile top, the horizontal plate directing the application force into the associate pile, the helmet structure further including at least one side plate transverse to the helmet base plate, the at least one side plate including the first accelerometer.

According to other aspects of the invention, provided is a pile testing system wherein the system further includes a striker device having a top side, a bottom side and at least one side wall, the top side facing the associated ram and the bottom side facing the transducer assembly.

According to yet other aspects of the invention, provided is a pile testing system wherein the system further including a cushion assembly between the striker device and the transducer assembly having a cushion assembly thickness.

According to even further aspects of the invention, provided is a pile testing system wherein the cushion assembly thickness is adjustable.

According to other aspects of the invention, provided is a pile testing system wherein the system further includes at least one retaining strap joined between the cushion assembly and the helmet structure to help hold the system together.

Further, these and other objects, aspects, features, developments and advantages of the invention of this application will become apparent to those skilled in the art upon a reading of the Detailed Description of Embodiments set forth below taken together with the drawings which will be described in the next section.

### BRIEF DESCRIPTION OF THE DRAWINGS

The invention may take physical form in certain parts and arrangement of parts, a preferred embodiment of which will be described in detail and illustrated in the accompanying drawings which form a part hereof and wherein:

FIG. 1 is an elevational view of applicant's APPLE system utilized both in the prior art and the system of this application;

FIG. 2 is a sectional view of a first set of embodiments;

FIG. 3 is a perspective view of a second set of embodiments; and,

FIG. 4 is a vertical sectional view of the embodiment shown in FIG. 3.

### DETAILED DESCRIPTION OF EMBODIMENTS

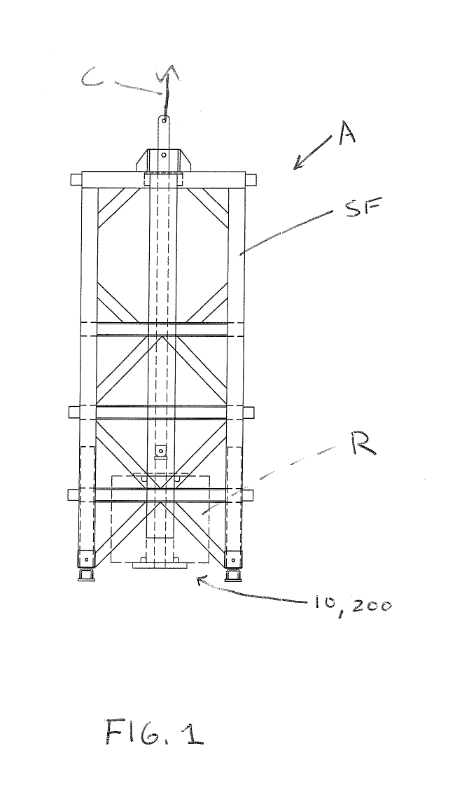

Referring now to the drawings wherein the showings are for the purpose of illustrating preferred and alternative embodiments of the invention only and not for the purpose of limiting same, FIGS. 1-4 show a system 10 that has been found to reduce testing cost and improve testing accuracy. This system can be used in connection with applicant's APPLE system shown in FIG. 1 and would be placed under ram R as is indicated in FIG. 1.

Throughout this specification, including the claims, there is reference to upward and downward directions. These are intended to help visualize and describe the invention with relation to the drawings and are not intended to limit the invention of this application. While the majority of tested piles are vertical piles, the invention of this application can be used on a wide variety of piles including those that are not vertical and/or perfectly vertical wherein the invention is not to be limited based on these terms.

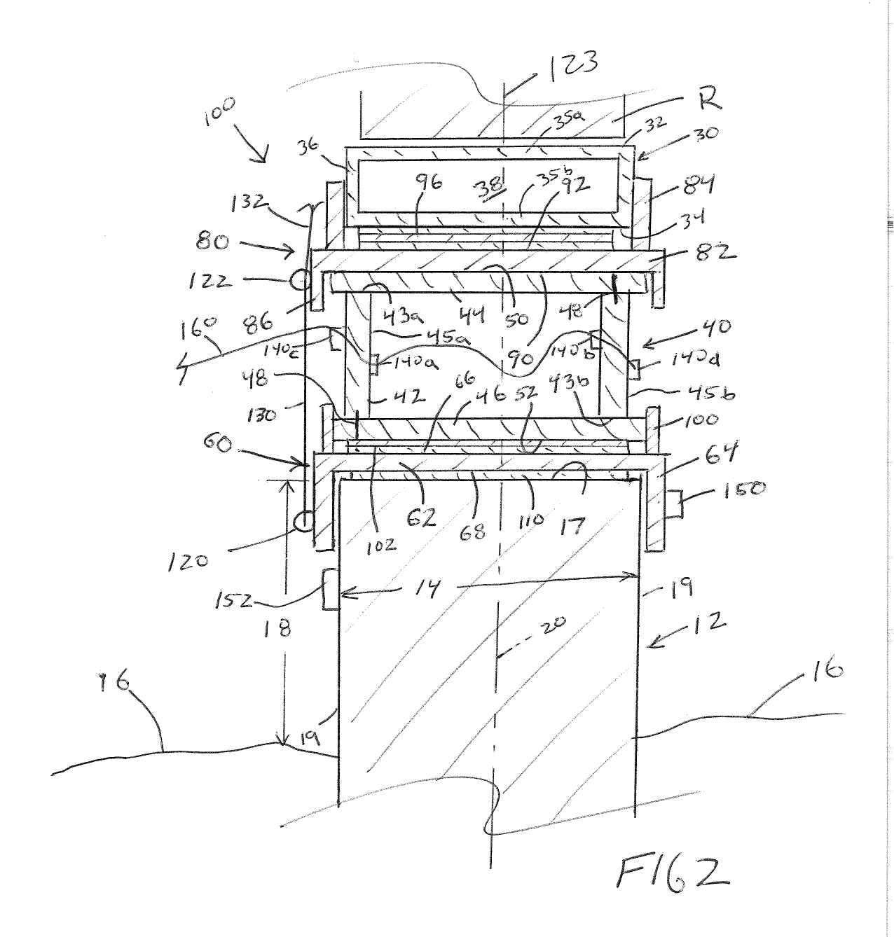

More particularly, and with particular reference to FIG. 2, system 10 is configured to test a pile 12 having a width or thickness 14. However, it should be noted that while a particle type of pile is shown, the invention of this application can be used with a wide range of piles and pile shapes wherein the invention of this application is not to be limited to the particular pile shown. For a cylindrical pile, the thickness 14 is also the diameter of the pile.

Pile 12 extends into a ground surface 16 a designated distance or depth (not shown) below ground surface 16. Further, pile 12 can extend upwardly above ground surface 16 and extends to a pile top 17 which can produce a top spacing 18 from ground surface 16. Pile 12 further includes at least one side surface 19 extending downwardly from top 17. As can be appreciated, a cylindrical pile can include a single side surface, but other pile shapes (not shown), such as a pile having a square cross-sectional configuration, can have multiple side surfaces. For the square pile, it would be four side surfaces. Pile 12 extends along a central pile axis 20 between the base of the pile (not shown) and pile top 17.

In at least one embodiment, system 10 is configured to rest directly on pile top 17 and can be configured to use side(s) 19 for alignment. In other embodiments, an intermediate layer can separate the system from the top of the file, which will be discussed in greater detail below. Further, it is preferred that system 10 be axially aligned with pile axis 20 so that the application forces are axially alignment with pile 12, which can be helped by the alignment features that will be discussed more below.

In one set of embodiments, system 10 includes a striker box 30 having a top side 32, a bottom side 34 and at least one side wall 36. As is shown, striker box 30 can be formed by a plate structure wherein top side 32 is formed by a top plate 35a and bottom side 34 is formed by a bottom plate 35b. Further side wall 36 can be one or more side plates wherein striker box can be a hollow structure having a central open space 38. In other embodiments, striker 30 could also be a solid structure or at least a partially solid structure.

System 10 further includes a transducer assembly 40 that can be positioned below striker box 30. The transducer assembly can have many configurations without detracting from the invention of this application. In one embodiment, the transducer assembly has a cylindrical configuration with a tubular side wall portion 42 having a top edge 43a and a bottom edge 43b. The transducer assembly further includes a top plate 44 engaging or bearing against top edge 43a and a bottom plate 46 engaging or bearing against bottom edge 43b. The side wall portion further includes an inner surface 45a and an outer surface 45b. In one set of embodiments, plates 44 and 46 both bear against the respective edges and in other sets of embodiments, top plate and/or bottom plate are removable wherein the plates can be removably attached to wall portion 42 by any means known in the art including, but not limited to, a plurality of fasteners 48. The transducer assembly includes an upper surface 50 and a lower surface 52 wherein upper surface 50 faces striker box 30 and lower surface 52 faces pile 12.

System 10 further includes a helmet structure 60 to protect the top of the pile. In one set of embodiments, the helmet structure can include one or more horizontal plate(s) 62. In other sets of embodiments, helmet structure can include and one or more side plate(s) 64 that can extend downwardly from top plate 62. The horizontal helmet plate includes an upper surface 66 that can be formed by plate 62 and a bottom surface 68 that can also be formed by plate 62 and/or an additional plate structured positioned below plate 62. With this configuration, upper surface 66 faces transducer assembly 40 and lower surface 68 faces pile 12. In operation upper surface 66 engages or bears against transducer assembly 40 and lower surface 68 engages or bears against pile top 17 of pile 12.

In yet further embodiments, system 10 can include one or more accelerometers attached to helmet structure 60, which will be discussed more below. Accelerometers can be used to help determine if the force in the pile is being accurately measured by the transducer tube by measuring the motion of the helmet. Accelerometers 150 can be attached to side plate 64 of the helmet in order to determine the inertia effect of the masses above the pile top and below the transducer assembly.

System 10 can also include accelerometers attached to the pile near the pile top to measure the motion and the inertia effects of the pile top mass above the pile accelerometers. This inertia effect can then be used to make a correction of the measured force. In one set of embodiments, the accelerometers are positioned between 200 mm and 300 mm below the pile top.

In yet other embodiments, system 10 further includes a cushion assembly 80 between striker box 30 and transducer assembly 40. In another set of embodiments, the cushion assembly can be adjustable wherein the cushion thickness can be adjusted to allow for testing with different load durations and loading rates. This is helpful when the sensitivity of the soil to different loading rates has to be evaluated. Cushion assembly 80 can take many forms and includes a base plate 82 and can include upwardly extending sides 84 and downwardly extending sides 86. These sides can be a single side wall and/or a plurality of side walls and can be configured to maintain the alignment between the striker box and the transducer assembly. As can be appreciated, all of these structures can be generally cylindrical in form wherein the respective side walls could be a single cylindrical side wall or can be polygonal in cross-sectional configuration without detracting from the invention of this application or variations thereof. Plate 82 can include a downwardly facing surface 90 that engages and/or bears against upward surface 50 directly or indirectly and an upwardly facing surface 92 that engages and/or bears against striker box 30.

As is noted above, cushion assembly 80 can be adjustable. In this respect, in other embodiments, cushion assembly 80 includes one or more cushioning layers 96 configured to cushion the blow from the applied load (which will be discussed more below) when it engages striker box 30. Side wall(s) 84 can be utilized to maintain the proper orientation of layers 96 along with cushion assembly 80 relative to striker box 30. Similarly, wall(s) 86 can be utilized to maintain the proper orientation of cushion assembly 80 relative to transducer assembly 40. As can be appreciated, the loads that are introduced by the ram into system 10 could cause adjacent parts to move relative to one another which can influence the system wherein these sidewalls can be used maintain a desired orientation without the need to fasten or join adjacent components.

Similarly, helmet 60 and/or transducer assembly 40 can include one or more side walls 100 to increase the rigidity of the component and/or to maintain the alignment between these components. Further, side walls 100 can be used to maintain the alignment of cushions or plates 102 between helmet 60 and assembly 40. And, can be used to maintain the alignment of the system on pile 12.

In yet other embodiments, system 10 includes one or more cushions 110 positioned between plate 62 and pile top 17 of pile 12. While not required, it is preferred that cushion 110 be a thin cushion to protect pile 12, but which will only produce a minimal amount of distortion to the data produced during the test. The thickness of this cushion sheet should be designed based on wave equation analysis studies and/or by matching the pile impedance.

In further embodiments, system 10 includes one or more supports 120 and 122 to maintain the components relative to one another. In particular, supports 120 and 122 can help maintain component relative to one another and can be used to transport and/or move system into or out of an operating position. As can be appreciated, positioning supports on a side of system 10 will require more than one support to lift the system. It is preferred that at least 3 supports 120 and 122 be positioned circumferentially about system axis 123 to allow a crane or lifting device (not shown) to securely support the system when it is lifted. More particularly, supports 120 are secured to helmet 60 and supports 122 are secured to cushion assembly 80. Supports 120 and 122 can then be joined to one another by a retaining cable or strap sections 130 that can hold system together when it is in operation and/or when it is transported into and out of the operating position. Further, system 10 can include lifting cables 132, which can work in connection with straps 130 to support system 10 as it is moved by a lifting device (not shown).

In the embodiment shown, the components of the system are positioned relative to the pile and essentially rest on the top of the pile. In yet a further set of embodiments (not shown), one or more components can be joined to ram R of the force generating device A. This can include one or more force measurement system and can include attaching accelerometers to the ram. Multiplying the ram acceleration (actually its deceleration) with the ram mass yields the force at the ram bottom, as long as the ram is relatively short (the ram may consist of a number of segments as long as they behave essentially rigid compared to the flexibility of the cushion assembly and pile. Helmet and pile acceleration have to be measured as in the case of the transducer situation.

As is discussed above, prior art testing systems required the force testing to be measured on the pile itself. This usually necessitated excavating into grown layer 16 a sufficient amount to secure sensors to the pile below the ground layer. Further, the hole size had to be large enough to allow onsite workers to both grind the outside of the pile to create a flat surface and to attach sensors to this flat surface on the pile. The invention of this application provides the ability to test forces at the top of the pile thereby reducing the need to disturb the ground around the pile to attach sensors directly to the pile in difficult and awkward conditions. However, sensors mounted directly to the pile can still be used without detracting from the invention of this application. But, as will discussed more below, attaching an accelerometer to the pile is easier than installing multiple sensors, particularly strain transducers. While the drawings are shown to have the pile with a significant top spacing 18, this is for description purposes only and is not needed for the invention of this application.

Contrary to the prior art, system 10 includes one or more strain transducers 140 including at least one strain transducer operably joined to transducer assembly 40 well above ground layer 16. These measurement devices are used to determine the force being produced by ram R. Transducers 140 can be any transducers known in the art or a mixture of transducers known in the art. System 10 also includes one or more accelerometers joined to the system and/or pile. In the embodiment shown, a first accelerometer 150 or set of accelerometers 150 is operably connected to helmet 60 and a second accelerometer 152 or set of accelerometers can be operably connected to pile 12.

In operation, ram R, which is of known weight, is dropped by system A or forced against striker box 30 and produces an application force against the system and through the system against the pile. The force applied by the ram can be determined by strain transducers 140. The movement of the pile and of the system can be monitored by accelerometers 150 and/or 152. This information can then be communicated to a data storage device and/or a computing device (not shown in the interest of brevity) wherein the data can be collected and/or used, as is known in the art, to determine the integrity of the pile. While only two accelerometers are shown, multiple accelerometers could be connected to the system and/or the pile. Multiple accelerometers can be used to help increase accuracy by averaging the data from each or for other testing reasons and by allowing for accounting for mass effects.

Similarly, more than one strain transducer can be utilized in system 10. Extra strain transducers can be used to increase the accuracy of the system wherein the data from all sensors can be compared to reduce error. An average can be used for the calculation of the applied load or impact force of the ram. Further, multiple strain transducers can be used to help confirm that the applied load is applied coaxial with the system and pile axis. Yet even further, the sensors can be joined to the outer and/or inner sides of the transducer assembly. As is shown, strain transducers 140a and 140b are mounted to inner surface(s) 45a while strain transducers 140c and 140d are mounted to outer surface(s) 45b. Mounting on both inner and outer walls can be used to increase accuracy by eliminating local bending effects. Mounting strain transducers to the transducer assembly makes replacements easy should and damage occur which is unlikely on the inside of the transducer assembly. Further, the inclusion of removable top and/or bottom plates makes the replacement of internal electronics easier.

This data can be delivered to the data storage device (not shown) and/or computing system (not shown) by wired 160 and/or by wireless system as referenced in the background of this specification and which is incorporated by reference into this specification. Further, a multi-channel system can be used to separate the signals from the different sensors in the system. This data management system can include, but is not limited to, applicant's PAX system and software. Similarly, the data produced by accelerometers 150 and 152 can also be compared. In this comparison, the force and energy loss between the system and the pile due to cushion 110 and helmet mass can be determined and accounted for.

Again, ram R can be any ram known in the art including, but not limited to, applicant's APPLE dynamic load system shown in FIG. 1.

The sensors utilized in system 10 can be removable sensors configured to be easily replaced as needed. These systems are often used in harsh conditions wherein it has been found that it is beneficial to utilize sensors that can be quickly replaced. Also, by utilizing transducer assembly 40 which includes a removable top and/or bottom plate, the end user can quickly access the sensors within the transducer assembly.

The system of this application can also be calibrated in a controlled environment. As can be appreciated, when sensors are joined directly to the pile itself, it is difficult to calibrate these sensors since they are applied in the field. The system of this application can be calibrated in a laboratory or test facility to ensure a high degree of accuracy. Further, static testing in a test facility can be utilized to calibrate the strain gauges and essentially determine the strain produces in wall portion 42 for a given force.

The size and configuration of transducer assembly 40 can also be adjusted to change the operating parameters of this system. In this respect, the length of wall portion 42 can be adjusted as desired to increase accuracy as needed. This can include lengthening wall or tubular portion 42 to increase the accuracy of the data produced by strain transducers 140. However, while this can increase measurement accuracy, it also increases the size and the weight of the system wherein a balance is needed. It has been found that the length of tubular portion 42 can be between 8 inches and 3 feet. In particular, between around 1 and 2 feet in length has been found to work well. But, this can change based on the forces used in the system which are produced by ram R.

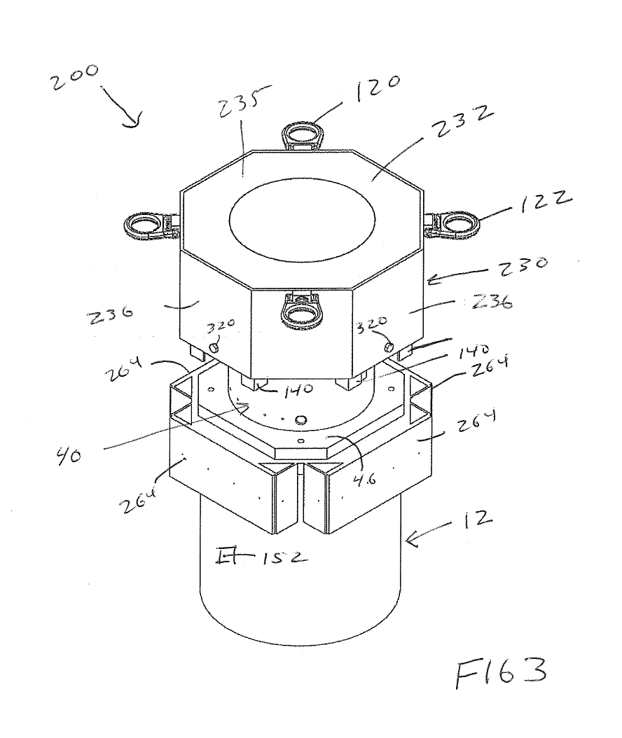

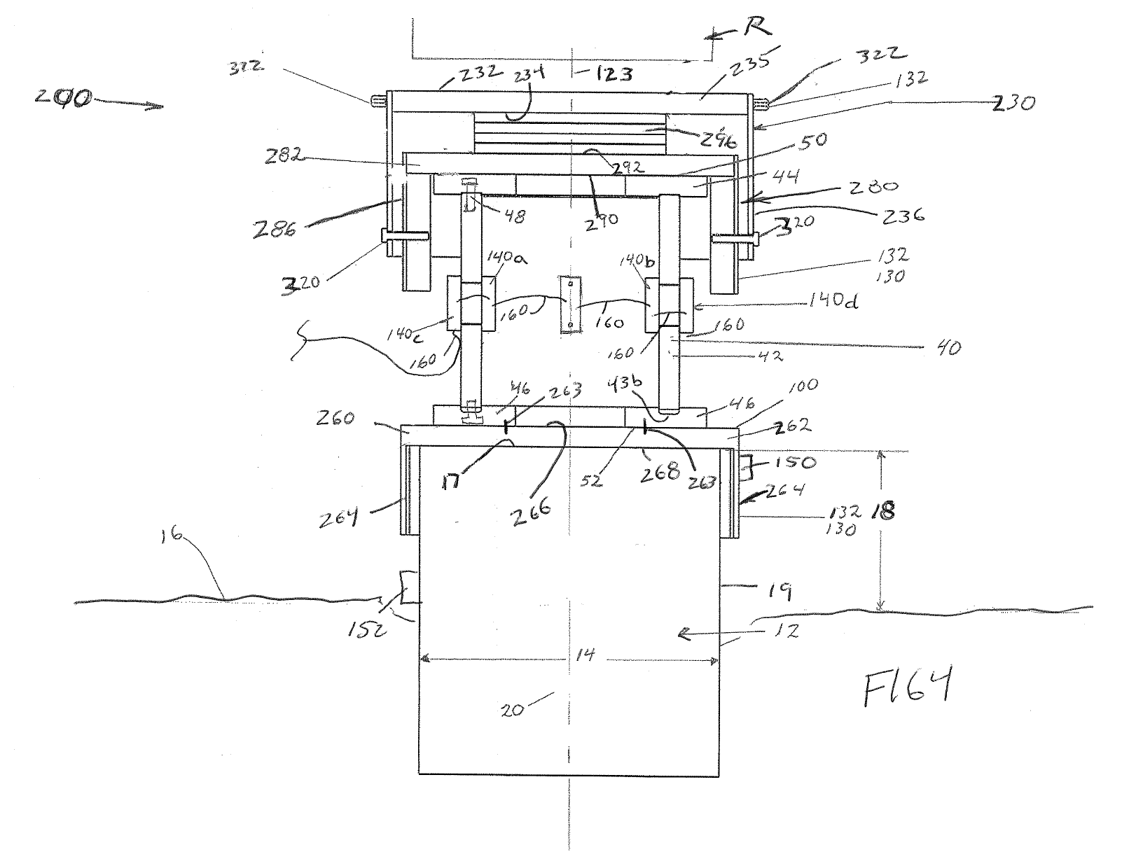

FIGS. 3 and 4 show yet other embodiments including possible modifications to the embodiments discussed above. Further, like reference numbers are used in the interest of brevity in relation to components that have at least similar characteristics as those discussed above. More particularly, shown is a pile testing system 200 that is also configured to rest or bear directly on pile top 17 and can be configured to use side(s) 19 for alignment.

In one set of embodiments, system 10 includes a striker plate assembly 230 having a top side 232, a bottom side 234 and at least one side wall 236. As is shown, striker plate assembly 230 can be formed by a plate structure wherein top side 232 is formed by a top plate 235 and bottom side 234 is also formed plate 235.

System 200 further includes a transducer assembly 40 as discussed above wherein assembly 40 will not be discussed in detail in the interest of brevity.

System 200 further includes a helmet structure 260 to protect the top of the pile. In one set of embodiments, the helmet structure includes a horizontal plate 262. In this set of embodiments, helmet structure includes four side walls or side plates 264 that can extend downwardly from top plate 262. The horizontal helmet plate includes an upper surface 266 that can be formed by plate 262 and a bottom surface 268 that can also be formed by plate 262 and/or an additional plate structured positioned below plate 262. With this configuration, upper surface 266 faces transducer assembly 40 and lower surface 268 faces pile 12. In operation upper surface 266 engages or bears against transducer assembly 40 and lower surface 268 engages or bears against pile top 17 of pile 12.

System 200 further includes one or more accelerometers and can include accelerometer(s) 150 operably connected to helmet structure 260 as discussed above. Accelerometers 150 can be attached to side plate 264 of the helmet in order to determine the inertia effect of the masses above the pile top and below the transducer assembly. System 200 can also include accelerometers 152 attached to the pile near the pile top to measure the motion and the inertia effects of the pile top mass above the pile accelerometers.

In yet other embodiments, system 200 further includes a cushion assembly 280 between striker assembly 230 and transducer assembly 40. Cushion assembly also can be adjustable wherein the cushion thickness can be adjusted to allow for testing with different load durations and loading rates. In this respect, cushion assembly 280 includes a base plate 282 and can include downwardly extending sides 286. Sides 286 can be a single side wall and/or a plurality of side walls and can be configured to maintain the alignment between the striker assembly and the transducer assembly. As is shown, sides 286 are octagonal in configuration with eight sides. Plate 282 can include a downwardly facing surface 290 that engages and/or bears against upward surface 50 directly or indirectly and an upwardly facing surface 292 that engages and/or bears against striker assembly 230.

As is noted above, cushion assembly 80 can be adjustable. In these embodiments, cushion assembly 280 includes one or more cushioning layers 296 that are positioned on top surface 292 and between surface 292 and bottom 234 of striker assembly 230. Side wall(s) 236 can be utilized to maintain the proper orientation of layers 296 along with cushion assembly 280 relative to striker assembly 230.

Helmet 260 and/or transducer assembly 40 can include one or more side walls (not shown) or fasteners 263 to increase the rigidity of the component and/or to maintain the alignment between these components. Further, any other fastening method known in the art can be used to secure these components, or others, relative to one another.

In yet other embodiments, system 200 includes one or more additional cushions (not shown) as described above between any of the assemblies while it is not required.

As with the embodiments above, system 200 can include one or more supports. In these embodiments, system 200 can include fasteners 320 to secure adjacent components and can include hoist rings 322 to transport and/or move system into or out of an operating position. As can be appreciated, positioning supports on a side of system 200 will require more than one support to lift the system. Further supports 120 could be utilized to maintain the components relative to one another in connection with strap 130.

The sensors utilized in system 200 also can be removable sensors configured to be easily replaced as needed.

The invention of this application has been found to make exceptional improvements in testing drilled shaft piles; however, this system can improve the testing of a wide variety of piles including, but not limited to drilled piles, auger cast piles, barrettes (slurry wall panels) and driven piles wherein this application is not to be limited to specific type of pile or support structure.

Again, as discussed above, the data collected by systems 10 and/or 200 of this application can be communicated locally or even to remote locations as desired. This can be done either by way or wired connections or by wireless systems. Further, this communication can be done as data is collected, at desired intervals and/or after one or more jobs are completed. Likins Jr. et al (U.S. Pat. No. 5,987,749); McVay et al (U.S. Pat. No. 6,533,502); and Piscalko (U.S. Pat. No. 6,301,551) are incorporated by reference for showing data collection, data use and data communication for the system of this application. Further, other systems known in the art could be utilized without detracting from the invention of this application.

While considerable emphasis has been placed on the preferred embodiments of the invention illustrated and described herein, it will be appreciated that other embodiments and/or equivalents thereof can be made and that many changes can be made in the preferred embodiments without departing from the principles of the invention. Accordingly, it is to be distinctly understood that the foregoing descriptive matter is to be interpreted merely as illustrative of the invention and not as a limitation.

It is claimed:

1. A pile testing system for determining the load capacity of an in place pile, the in place pile having a pile top and at least one pile side surface, the system comprising a transducer assembly having a top extent and a oppositely facing bottom extent, the top extent facing an associate ram configured to provide an application force against the system, the bottom extent facing an associated top of an associated in place pile to be tested and which is positioned in an associated ground layer, the associated pile having a central pile axis extending into the associate ground layer, the transducer assembly being generally fixed relative the associated pile top when in use, the transducer assembly further including at least one side wall transverse to the associated pile top and generally extending about a transducer assembly axis, the transducer assembly further including at least one strain transducer operably joined to the at least one side wall of the transducer assembly, the at least one strain transducer configured to measure the applied load, the system further including at least one accelerometer fixed relative to the associated pile, the at least one accelerometer configured to calculate the movement of the associated pile when subjected to the applied load wherein the load capacity of the associated in place pile can be calculated based on the comparison between the applied load and the movement of the pile.

2. The pile testing system of claim 1 wherein the at least one strain transducer is operably joined to the at least one side wall includes a transducer operably joined to an inner surface of the at least one side wall of the transducer assembly.

3. The pile testing system of claim 2 wherein the transducer assembly further includes a top plate and a bottom plate, at least one of the top and bottom plates being selectively removable to access the at least one strain transducer operably joined to the inner surface.

4. The pile testing system of claim 3 wherein the at least one strain transducer is at least one inner strain transducer operably joined to the inside surface and the system further includes at least one outer strain transducer operably joined to an outer surface of the at least one side wall of the transducer assembly.

5. The pile testing system of claim 4 wherein the at least one side wall is a cylindrical side wall.

6. The pile testing system of claim 5 wherein the at least one inner strain transducer is a plurality of inner strain transducers circumferentially spaced about cylindrical side wall and the at least one outer strain transducer is a plurality of outer strain transducers circumferentially spaced about cylindrical side wall.

7. The pile testing system of claim 6, the plurality of inner strain transducers being equidistant to the transducer assembly axis and plurality of outer strain transducers being equidistant to the transducer assembly axis, the plurality of inner and outer strain transducers together measuring the applied load to both improve accuracy and detect misdirected load application.

8. The pile testing system of claim 6 further including a helmet structure separating the transducer assembly from the associated pile, the helmet structure bearing against the associated top of the pile and the transducer assembly bearing against the helmet structure when the application force against the system is applied, the at least one accelerometer including a first accelerometer being operably secured to at least one of the helmet structure and an associated side surface of the associated pile.

9. The pile testing system of claim 8 wherein the at least one accelerometer further includes a second accelerometer, the second accelerometer being operably joined to the other of the at least one of the helmet structure and the associated side surface.

10. The pile testing system of claim 8 wherein at least one of the helmet structure directly engages the associate pile top and the transducer assembly directly engages the helmet structure.

11. The pile testing system of claim 1 further including a helmet structure separating the transducer assembly from the associated pile, the helmet structure bearing against the associated top of the pile and the transducer assembly bearing against the helmet structure when the application force against the system is applied, the at least one accelerometer including a first accelerometer being operably secured to at least one of the helmet structure and an associated side surface of the associated pile.

12. The pile testing system of claim 9 wherein the helmet structure includes a horizontal plate having a top surface facing the transducer assembly and a bottom surface facing the associated pile top, the horizontal plate directing the application force into the associate pile, the helmet structure further including at least one side plate transverse to the helmet base plate, the at least one side plate including the first accelerometer.

13. The pile testing system of claim 12 wherein the at least one side plate is a plurality of side plates spaced about the transducer assembly axis.

14. The pile testing system of claim 11 further including at least one cushion between at least one of the transducer assembly, the helmet structure and the associate pile top.

15. The pile testing system of claim 8 further including a striker device having a top side, a bottom side and at least one side wall, the top side facing the associated ram and the bottom side facing the transducer assembly.

16. The pile testing system of claim 15 further including a cushion assembly between the striker device and the transducer assembly having a cushion assembly thickness.

17. The pile testing system of claim 16 wherein the cushion assembly thickness is adjustable.

18. The pile testing system of claim 16 wherein the striker assembly includes a striker box having a top striker plate and a bottom striker plate with at least one side striker wall joining the top and bottom striker plates, the cushion assembly being between the bottom striker plate and the transducer assembly.

19. The pile testing system of claim 16 wherein the striker assembly includes a striker plate and at least one downwardly extending side striker wall joined to the striker plates, the cushion assembly being between the striker plate and the transducer assembly.

20. The pile testing system of claim 19 wherein the cushion assembly includes a cushion plate parallel to the striker plate and a downwardly extending member joined to the cushion plate, the cushion assembly further including at least one cushioning plate between the striker plate and the cushion plate.

21. The pile testing system of claim 12 further include at least one retaining strap joined between the cushion assembly and the helmet structure to help hold the system together.

22. The pile testing system of claim 1 further including a striker device having a top side, a bottom side and at least one side wall, the top side facing the associated ram and the bottom side facing the transducer assembly.

23. The pile testing system of claim 22 further including a cushion assembly between the striker device and the transducer assembly having a cushion assembly thickness.

24. The pile testing system of claim 23 wherein the cushion assembly thickness is adjustable.

25. The pile testing system of claim 23 wherein the striker assembly includes a striker box having a top striker plate and a bottom striker plate with at least one side striker wall joining the top and bottom striker plates, the cushion assembly being between the bottom striker plate and the transducer assembly.

26. The pile testing system of claim 23 wherein the striker assembly includes a striker plate and at least one downwardly extending side striker wall joined to the striker plate, the cushion assembly being between the striker plate and the transducer assembly.

27. The pile testing system of claim 26 wherein the cushion assembly includes a cushion plate parallel to the striker plate and a downwardly extending member joined to the cushion plate, the cushion assembly further including at least one cushioning plate between the striker plate and the cushion plate.
